(19) United States
(12) Patent Application Publication
(10) Pub. No.: US 2026/0061864 A1
(43) Pub. Date: Mar. 5, 2026

(54) ELECTRIFIED VEHICLE

(71) Applicant: TOYOTA JIDOSHA KABUSHIKI KAISHA, Toyota-shi (JP)

(72) Inventor: Koichi NAKAMURA, Miyoshi-shi (JP)

(73) Assignee: TOYOTA JIDOSHA KABUSHIKI KAISHA, Toyota-shi (JP)

(21) Appl. No.: 19/189,477

(22) Filed: Apr. 25, 2025

(30) Foreign Application Priority Data
Sep. 3, 2024 (JP) 2024-151259

(51) Int. Cl. B60L 50/60; B60K 1/04; B60L 50/51

(52) U.S. Cl. CPC B60L 50/66; B60K 1/04; B60L 50/51; B60K 2001/0438; B60L 2210/14; B60L 2210/40

(57) ABSTRACT

An electrified vehicle includes an integrated electromechanical unit and a dash panel. The dash panel is supported by a framework member. The framework member is provided below the dash panel, and is located rearward of the integrated electromechanical unit in the vehicle front-rear direction. The battery pack is disposed rearward of a front end of the framework member in the vehicle front-rear direction. A surface of the integrated electromechanical unit that faces the framework member includes a first protrusion protruding in the vehicle length direction. A surface of the framework member that faces the integrated electromechanical unit includes a second protrusion protruding in the vehicle length direction. The distance between these surfaces is smaller than the distance between the surface of the integrated electromechanical unit that faces the framework member and the front end of the battery pack in the vehicle length direction.

### CROSS-REFERENCE TO RELATED APPLICATION

This application claims priority to Japanese Patent Application No. 2024-151259 filed on September 3, 2024, incorporated herein by reference in its entirety.

### BACKGROUND

### 1. Technical Field

The present disclosure relates to electrified vehicles.

### 2. Description of Related Art

WO 2014/038530 discloses an electrified vehicle including an integrated electromechanical structure. The integrated electromechanical structure includes, in front of a dash panel, a motor, an inverter, and a direct current-to-direct current (DC-DC) converter. The dash panel separates a vehicle cabin and a motor compartment. That is, this electrified vehicle includes an integrated electromechanical unit in front of the dash panel.

### SUMMARY

When an electrified vehicle equipped with an integrated electromechanical unit in the front part of the vehicle is involved in a frontal collision, the integrated electromechanical unit moved toward the rear of the vehicle due to the impact of the frontal collision may come into contact with a battery pack disposed rearward of the integrated electromechanical unit in the vehicle front-rear direction.

The present disclosure provides an electrified vehicle that solves the above issue. An electrified vehicle of the present disclosure is configured to drive a drive wheel by electric power stored in a battery cell inside a battery pack. The electrified vehicle includes an integrated electromechanical unit that is an integrated combination of a motor and a power control device. The motor is a power source configured to drive the drive wheel. The power control device is configured to supply the electric power of the battery cell to the motor. In the electrified vehicle, the integrated electromechanical unit is disposed inside a front compartment. In the electrified vehicle, the front compartment and a vehicle cabin located rearward of the front compartment in a vehicle front-rear direction are separated by a dash panel. The dash panel is supported by a framework member. The framework member is provided below the dash panel, and is located rearward of the integrated electromechanical unit in the vehicle front-rear direction. The battery pack is joined to a lower surface of the framework member, and is disposed below a floor in the vehicle cabin at a position rearward of a front end of the framework member in the vehicle front-rear direction. Either or both of a surface of the integrated electromechanical unit that faces the framework member and a surface of the framework member that faces the integrated electromechanical unit include a protrusion protruding in a vehicle length direction. In the electrified vehicle, the distance between the surface of the integrated electromechanical unit that faces the framework member and the surface of the framework member that faces the integrated electromechanical unit is smaller than the distance between the surface of the integrated electromechanical unit that faces the framework member and a front end of the battery pack in the vehicle length direction.

The above electrified vehicle can reduce the possibility that the integrated electromechanical unit and the battery pack may come into contact with each other in the event of a frontal collision.

### BRIEF DESCRIPTION OF THE DRAWINGS

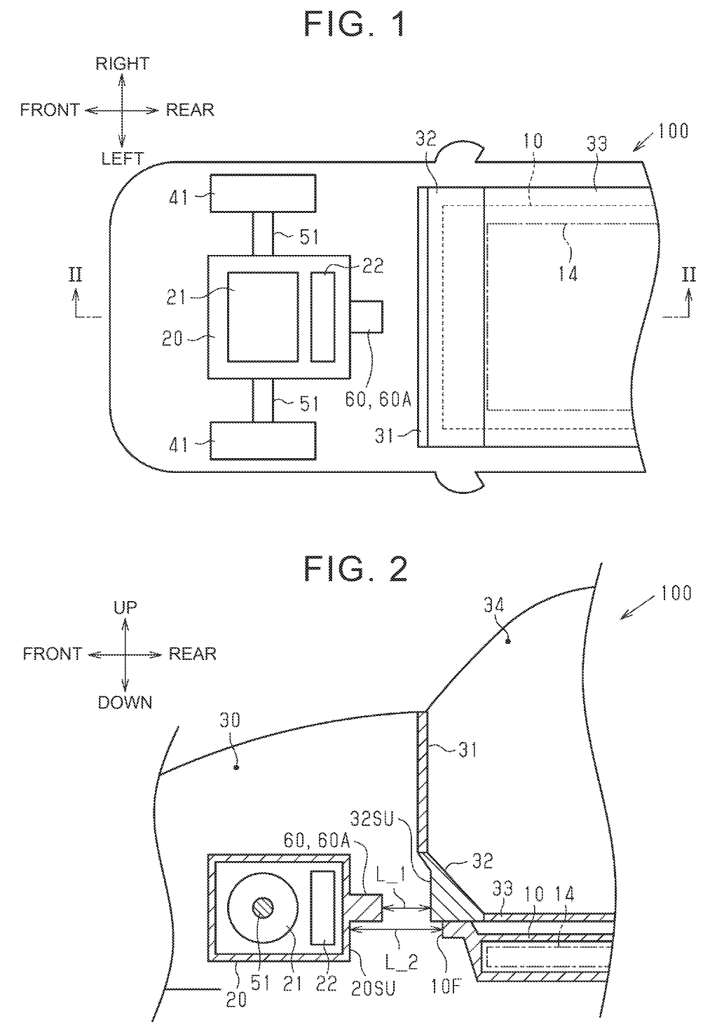

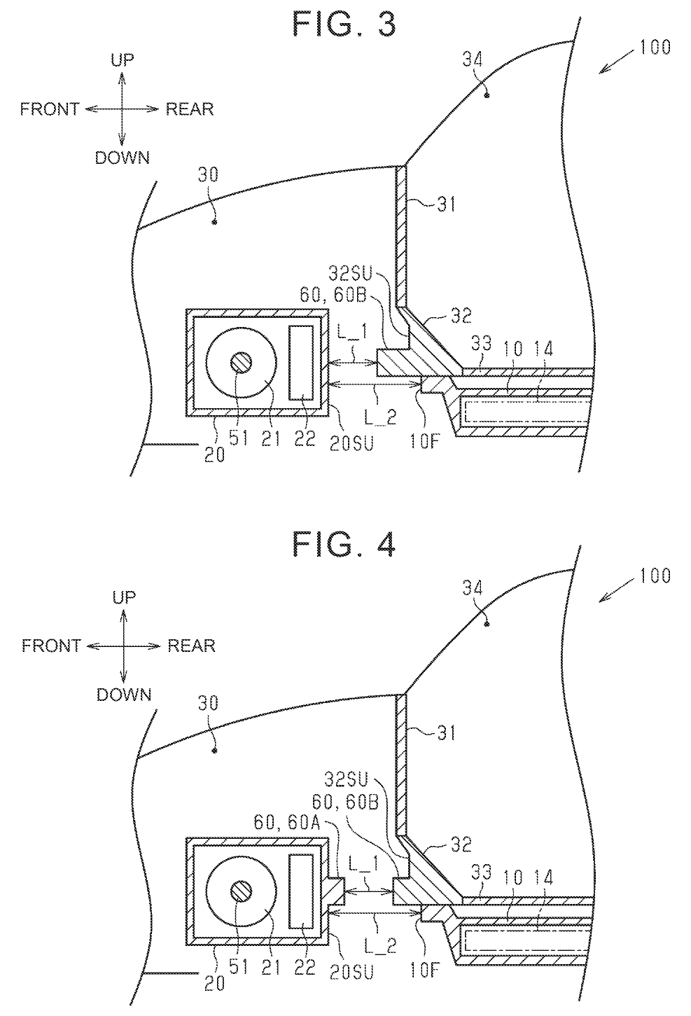

Features, advantages, and technical and industrial significance of exemplary embodiments of the disclosure will be described below with reference to the accompanying drawings, in which like signs denote like elements, and wherein: FIG. 1 is a schematic diagram illustrating the arrangement of devices in an electrified vehicle device according to a first embodiment; FIG. 2 is a sectional view of the electrified vehicle taken along line II-II in FIG. 1; FIG. 3 is a sectional view of an electrified vehicle according to a modification of the first embodiment; and FIG. 4 is a sectional view of an electrified vehicle according to a second embodiment.

### DETAILED DESCRIPTION OF EMBODIMENTS

### First Embodiment

An electrified vehicle according to a first embodiment will be described below with reference to FIGS. 1 and 2. In the following description, "front," "rear," "right," "left," "upper," and "lower" refer to "front," "rear," "right," "left," "upper," and "lower" as viewed from a passenger facing toward the front of the vehicle. The lateral direction coincides with the vehicle width direction.

### Configuration of Electrified Vehicle 100

FIG. 1 is a schematic view showing the arrangement of devices when the electrified vehicle 100 is viewed from above. As shown in FIG. 1, the electrified vehicle 100 includes a pair of right and left front wheels 41, a drive shaft 51, an integrated electromechanical unit 20, a dash panel 31, a framework member 32, a floor 33, and a battery pack 10. The battery pack 10 shown by a dashed line is disposed below the framework member 32 and the floor 33. A plurality of battery cells 14 are housed in the battery pack 10. In FIGS. 1 to 4, a plurality of battery cells 14 laid in a battery pack are collectively indicated by a long dashed short dashed line.

The integrated electromechanical unit 20 includes a first protrusion 60A as a protrusion 60 that protrudes in the vehicle length direction. The integrated electromechanical unit 20 is an integrated unit of the motor 21 and the power control device 22. The power control device 22 is disposed on the side surface of the motor 21 behind the motor 21 in the vehicle front-rear direction. In the electrified vehicle 100, the power control device 22 in the integrated electromechanical unit 20 may be disposed at a position other than behind the motor 21 in the vehicle front-rear direction. For example, in the integrated electromechanical unit 20, the power control device 22 may be disposed in front of the motor 21 in the vehicle front-rear direction. For example, the integrated electromechanical unit 20 may be disposed such that the power control device 22 overlaps the motor 21 in the up-down direction. For example, in the integrated electromechanical unit 20, the power control device 22 and the motor 21 may be disposed so as to overlap each other when viewed from the side of the vehicle.

The motor 21 is a power source that drives the front wheels 41 that are drive wheels via the drive shaft 51. The plurality of battery cells 14 inside the battery pack 10 stores electric power to be supplied to the motor 21. That is, the electrified vehicle 100 drives the drive wheels by the electric power stored in the plurality of battery cells 14.

The power control device 22 is a device that supplies electric power to the motor 21. The power control device 22 includes an inverter that converts direct current power from the plurality of battery cells 14 to alternating current power and supplies the alternating current power to the motor 21. The integrated electromechanical unit 20 may include a device other than an inverter as the power control device 22. The integrated electromechanical unit 20 may include, in addition to the inverter, a DC-DC converter that boosts the direct current power supplied from the plurality of battery cells 14. The inverter provided as the power control device 22 converts the direct current power supplied from the DC-DC converter to alternating current power and supplies the alternating current power to the motor 21. The integrated electromechanical unit 20 may include, as the power control device 22, an ECU (Electronic Control Unit) that controls electric power to be supplied to the motor 21. The ECU includes a CPU and a memory in which control programs and data are stored. The ECU executes processes for various controls by the CPU executing the programs stored in the memories.

FIG. 2 is a schematic section of the electrified vehicle 100 in FIG. 1 taken along line II-II in FIG. 1. As shown in FIG. 2, in the electrified vehicle 100, a front compartment 30 and a vehicle cabin 34 located rearward of the front compartment 30 in the vehicle front-rear direction are separated by a dash panel 31. In the electrified vehicle 100, the integrated electromechanical unit 20 is disposed inside the front compartment 30. The dash panel 31 is supported by a framework member 32. The framework member 32 is provided below the dash panel 31. The framework member 32 is located rearward of the integrated electromechanical unit 20 in the vehicle front-rear direction.

The battery pack 10 is joined to the lower surface of the framework member 32. Accordingly, the battery pack 10 is disposed under the floor 33 in the vehicle cabin 34. For example, the battery pack 10 is fastened to the lower surface of the framework member 32 by a fastening member, not shown. The battery pack 10 and the lower surface of the framework member 32 may be joined to each other via brackets. The battery pack 10 is disposed rearward of the front end of the framework member 32 in the vehicle front-rear direction. Specifically, the front end 10F of the battery pack 10 in the vehicle length direction is located rearward of the surface 32SU of the framework member 32 that faces the integrated electromechanical unit 20, namely rearward of the front end of the framework member 32, in the vehicle front-rear direction.

### Protrusion 60 Protruding in Vehicle Length Direction

The electrified vehicle 100 has a first protrusion 60A on a surface 20SU of the integrated electromechanical unit 20 facing the framework member 32 as a protrusion 60 protruding in the vehicle length direction.

"L_1" shown in FIG. 2 is a distance between a surface 20SU of the integrated electromechanical unit 20 facing the framework member 32 and a surface 32SU of the framework member 32 facing the integrated electromechanical unit 20. In the first embodiment, "L_1" is the distance between the rear end of the first protrusion 60A in the vehicle length direction and the surface 32SU. "L_2" is the distance between the surface 20SU of the integrated electromechanical unit 20 that faces the framework member 32 and the front end 10F of the battery pack 10 in the vehicle length direction. The length of "L_1" is smaller than the length of "L_2". That is, the distance between the surface 20SU and the surface 32SU is smaller than the distance between the surface 20SU and the front end 10F of the battery pack 10 in the vehicle length direction.

### Functions of First Embodiment

The electrified vehicle 100 has a first protrusion 60A on the surface 20SU. In the electrified vehicle 100, the distance between the surface 20SU and the surface 32SU is smaller than in an electrified vehicle in which the surface 20SU and the surface 32SU do not include the protrusion 60 protruding in the vehicle length direction. As a result, when the electrified vehicle 100 is involved in a frontal collision, the integrated electromechanical unit 20 moved toward the rear of the vehicle due to the impact is likely to come into contact with the framework member 32 before it comes into contact with the battery pack 10. The integrated electromechanical unit 20 is less likely to be moved further rearward because it comes into contact with the framework member 32. Therefore, in the electrified vehicle 100, the integrated electromechanical unit 20 is less likely to get closer to the battery pack 10.

### Effects of First Embodiment

(1-1) The electrified vehicle 100 can reduce the possibility that the integrated electromechanical unit 20 and the battery pack 10 come into contact with each other in the event of a frontal collision.

### Modifications of First Embodiment

The first embodiment can be modified as follows. Modifications of the first embodiment described above and the first embodiment described below can be implemented in combination with each other as long as they are not technically contradictory.

In the electrified vehicle 100, either or both of the surface 20SU of the integrated electromechanical unit 20 and the surface 32SU of the framework member 32 may include the protrusion 60 protruding in the vehicle length direction. The surface 20SU of the integrated electromechanical unit 20 faces the framework member 32. The surface 32SU of the framework member 32 faces the integrated electromechanical unit 20. For example, in the electrified vehicle 100 shown in FIG. 3, the surface 32SU of the framework member 32 that faces the integrated electromechanical unit 20 include a second protrusion 60B as the protrusion 60 protruding in the vehicle length direction. The electrified vehicle 100 shown in FIG. 3 does not include, on the surface 20SU of the integrated electromechanical unit 20 facing the framework member 32, a protrusion 60 protruding in the vehicle length direction. "L_1" shown in FIG. 3 is the distance between the surface 20SU and the front end of the second protrusion 60B in the vehicle length direction. "L_2" shown in FIG. 3 is the distance between the surface 20SU of the integrated electromechanical unit 20 that faces the framework member 32 and the front end 10F of the battery pack 10 in the vehicle length direction, like "L_2" shown in FIG. 2. In FIG. 3, as in FIG. 2, the length of "L_1" is smaller than the length of "L_2". That is, the distance between the surface 20SU and the surface 32SU is smaller than the distance between the surface 20SU and the front end 10F of the battery pack 10 in the vehicle length direction. The same advantages as those of the electrified vehicle 100 of the first embodiment can also be obtained.

### Second Embodiment

Hereinafter, an electrified vehicle 100 according to a second embodiment will be described with reference to FIG. 4. In the second embodiment, differences from the first embodiment will be mainly described, and description of the same points will be simplified or omitted.

As shown in FIG. 4, in the electrified vehicle 100, the surface 20SU of the integrated electromechanical unit 20 that faces the framework member 32 includes a first protrusion 60A as the protrusion 60 protruding in the vehicle length direction. In addition, in the electrified vehicle 100, the surface 32SU of the framework member 32 that faces the integrated electromechanical unit 20 includes a second protrusion 60B as the protrusion 60 protruding in the vehicle length direction. That is, in the electrified vehicle 100, both the surface 20SU of the integrated electromechanical unit 20 and the surface 32SU of the framework member 32 include the protrusion 60. The surface 20SU of the integrated electromechanical unit 20 faces the framework member 32. The surface 32SU of the framework member 32 faces the integrated electromechanical unit 20.

In addition, in the electrified vehicle 100, the protrusion 60 is provided at positions facing each other in the vehicle length direction on both the surface 20SU and the surface 32SU. That is, in the electrified vehicle 100, the first protrusion 60A of the surface 20SU and the second protrusion 60B of the surface 32SU face each other in the vehicle length direction.

"L_1" shown in FIG. 4 is the distance between the surface 20SU of the integrated electromechanical unit 20 that faces the framework member 32 and the surface 32SU of the framework member 32 that faces the integrated electromechanical unit 20. In the second embodiment, "L_1" is the distance between the rear end of the first protrusion 60A in the vehicle length direction and the front end of the second protrusion 60B in the vehicle length direction. "L_2" shown in FIG. 4 is the distance between the surface 20SU of the integrated electromechanical unit 20 that faces the framework member 32 and the front end 10F of the battery pack 10 in the vehicle length direction, like "L_2" shown in FIGS. 2 and 3.

The length of "L_1" shown in FIG. 4 is equal to the length of "L_1" shown in FIGS. 2 and 3. Similarly, the length of "L_2" shown in FIG. 4 is equal to the length of "L_2" shown in FIGS. 2 and 3. The dimension of the first protrusion 60A shown in FIG. 4 in the vehicle length direction is smaller than the dimension of the first protrusion 60A shown in FIG. 2 in the vehicle length direction. The dimension of the second protrusion 60B shown in FIG. 4 in the vehicle length direction is smaller than the dimension of the second protrusion 60B shown in FIG. 3 in the vehicle length direction.

### Functions of Second Embodiment

A plurality of electrified vehicles 100 having the same distance between the surface 20SU and the surface 32SU will be compared below. In the electrified vehicle 100 of the second embodiment, the dimension of the first protrusion 60A in the vehicle length direction is smaller than in the electrified vehicle 100 including only the first protrusion 60A out of the first protrusion 60A and the second protrusion 60B. In the electrified vehicle 100 of the second embodiment, the dimension of the second protrusion 60B in the vehicle length direction is smaller than in the electrified vehicle 100 including only the second protrusion 60B out of the first protrusion 60A and the second protrusion 60B.

### Effects of Second Embodiment

The configuration of the second embodiment has the same effect that described in (1-1) of the first embodiment. The configuration of the second embodiment further has the following effect.

(2-1) The electrified vehicle 100 includes a shorter protrusion 60. Therefore, the distance between the surface 20SU and the surface 32SU can be made smaller than the distance between the surface 20SU and the front end 10F of the battery pack 10 in the vehicle length direction.

### Modifications of Second Embodiment

The second embodiment can be modified as follows. Modifications of the second embodiment described above and the second embodiment described below can be implemented in combination with each other as long as they are not technically contradictory.

In the electrified vehicle 100, the protrusion 60 may not be provided at positions facing each other in the vehicle length direction on both the surface 20SU of the integrated electromechanical unit 20 and the surface 32SU of the framework member 32. The surface 20SU of the integrated electromechanical unit 20 faces the framework member 32. The surface 32SU of the framework member 32 faces the integrated electromechanical unit 20. For example, in the electrified vehicle 100, the first protrusion 60A and the second protrusion 60B may be provided apart from each other in the vehicle up-down direction. In the electrified vehicle 100, the first protrusion 60A and the second protrusion 60B may be provided apart from each other in the vehicle width direction. Even in these cases, in the electrified vehicle 100 of the second embodiment, the distance between the surface 20SU and the surface 32SU is smaller than the distance between the surface 20SU and the front end 10F of the battery pack 10 in the vehicle length direction. The electrified vehicle 100 of the second embodiment has the same effects as those of the electrified vehicle 100 of the first embodiment even through the protrusion 60 is not provided at positions facing each other in the vehicle length direction on both the surface 20SU and the surface 32SU.

What is claimed is:

1. An electrified vehicle configured to drive a drive wheel by electric power stored in a battery cell inside a battery pack, the electrified vehicle comprising an integrated electromechanical unit that is an integrated combination of a motor and a power control device, the motor being a power source configured to drive the drive wheel, and the power control device being configured to supply the electric power of the battery cell to the motor, wherein:
the integrated electromechanical unit is disposed inside a front compartment;
the front compartment and a vehicle cabin located rearward of the front compartment in a vehicle front-rear direction are separated by a dash panel;
the dash panel is supported by a framework member, the framework member being provided below the dash panel and located rearward of the integrated electromechanical unit in the vehicle front-rear direction;
the battery pack is joined to a lower surface of the framework member, and is disposed below a floor in the vehicle cabin at a position rearward of a front end of the framework member in the vehicle front-rear direction;
either or both of a surface of the integrated electromechanical unit that faces the framework member and a surface of the framework member that faces the integrated electromechanical unit include a protrusion protruding in a vehicle length direction; and
a distance between the surface of the integrated electromechanical unit that faces the framework member and the surface of the framework member that faces the integrated electromechanical unit is smaller than a distance between the surface of the integrated electromechanical unit that faces the framework member and a front end of the battery pack in the vehicle length direction.

2. The electrified vehicle according to claim 1, wherein, of the surface of the integrated electromechanical unit that faces the framework member and the surface of the framework member that faces the integrated electromechanical unit, the surface of the integrated electromechanical unit that faces the framework member includes the protrusion.

3. The electrified vehicle according to claim 1, wherein, of the surface of the integrated electromechanical unit that faces the framework member and the surface of the framework member that faces the integrated electromechanical unit, the surface of the framework member that faces the integrated electromechanical unit includes the protrusion.

4. The electrified vehicle according to claim 1, wherein both of the surface of the integrated electromechanical unit that faces the framework member and the surface of the framework member that faces the integrated electromechanical unit includes the protrusion.

5. The electrified vehicle according to claim 1, wherein the protrusion is provided at positions facing each other in the vehicle length direction on both the surface of the integrated electromechanical unit that faces the framework member and the surface of the framework member that faces the integrated electromechanical unit.
